(19) United States
(12) Patent Application Publication
(10) Pub. No.: US 2012/0317243 A1
(43) Pub. Date: Dec. 13, 2012

(54) AUDIO PROCESSING METHOD AND DEVICE FOR REMOTE DESKTOP PROTOCOL

(75) Inventors: Zhannian Gao, Beijing (CN); Chengkun Sun, Beijing (CN)

(73) Assignees: BEIJING LENOVO SOFTWARE LTD., Beijing (CN); LENOVO (BEIJING) LIMITED, Beijing (CN)

(21) Appl. No.: 13/576,533

(22) PCT Filed: Jan. 31, 2011
(86) PCT No.: PCT/CN2011/000179

§ 371 Date: Aug. 1, 2012

(30) Foreign Application Priority Data
Feb. 8, 2010 (CN) 201010109444.0

(51) Int. Cl. G06F 15/16

(52) U.S. Cl. 709/219

(57) ABSTRACT

An audio processing method and device for remote desktop protocol are provided. The method includes steps of establishing a first channel by initiating a connection with a client upon receiving an audio transmission request from an operating system of a server; and receiving audio data and transmitting the audio data to the client via the first channel. With the solutions provided by the embodiments of the present invention, the connection is initiated with the client after receiving the audio transmission request from the operating system of the server. In this way, a dedicated channel is established for transmitting the audio data and the audio data is transmitted to the client via the dedicated channel.

### TECHNICAL FIELD

The present invention relates to computer and communication technologies, and more particularly, to an audio processing method and device for remote desktop protocol.

### BACKGROUND

Remote Desktop Protocol (RDP) mainly includes a client and a server. Many existing systems, such as Windows XP system, include both a client and a server. That is, a computer having Windows XP system can function as a client to be connected with and control another computer also having Windows XP system, or as a server controlled by another computer.

A desktop of a remote computer can be connected by means of remote desktop management. The remote computer can be controlled to achieve various operations such as sending/receiving e-mail, watching movie, listening to music and performing user management, just like operating a local computer.

The inventor finds that in the research on the prior art that audio drivers provided by current systems perform a complicated processing flow on audio data and typically suffer from a high output delay. The output delays of some systems are even up to 1 second. Such a high delay affects the user experience. For example, when a user is watching a movie via RDP, the audio and the video can be significantly out of sync with each other, which will affect the watching experience.

### SUMMARY

In light of this, it is an object of the present invention to provide an audio processing method and device for remote desktop protocol, capable of simplifying the processing flow performed by a server on audio data and reducing the delay of the audio data.

In order to achieve the above object, according to an aspect of the present invention, an audio processing method for remote desktop protocol is provided, comprising steps of: establishing a first channel by initiating a connection with a client upon receiving an audio transmission request from an operating system of a server; and receiving audio data and transmitting the audio data to the client via the first channel.

According to a preferred embodiment, the step of establishing the first channel includes: generating an audio play device object creation command; creating a first audio play device object at the server based on the audio play device object creation command; and establishing the first channel between the server and the client based on the first audio play device object.

According to a preferred embodiment, the step of transmitting the audio data to the client via the first channel includes: transmitting the audio play device object creation command to the client via the first channel; creating a second audio play device object at the client based on the audio play device object creation command; and transmitting the audio data from the server to the second audio play device object at the client using the first audio play device object at the server.

According to a preferred embodiment, the method further comprises steps of: calculating an audio data transmission parameter and transmitting the audio data transmission parameter to the operating system of the server, such that the operating system of the server controls the transmission of the audio data based on the audio data transmission parameter.

According to another aspect of the present invention, an audio processing method for remote desktop protocol is provided, comprises steps of: establishing a second channel by initiating a connection with a client upon receiving an audio reception request from an operating system of a server; and receiving audio data transmitted from the client via the second channel.

According to a preferred embodiment, the step of establishing the second channel comprises steps of: generating an audio reception device object creation command; creating a first audio reception device object at the server based on the audio reception device object creation command; and establishing the second channel between the server and the client based on the first audio reception device object.

According to a preferred embodiment, the step of receiving audio data transmitted from the client via the second channel comprises steps of: transmitting the audio reception device object creation command to the client via the second channel; creating a second audio reception device object at the client based on the audio reception device object creation command; and receiving the audio data using the second audio reception device object at the client and transmitting the received audio data to the first audio reception device object at the server via the second channel.

According to a preferred embodiment, the method further comprises steps of: receiving an audio reception termination command for notifying the client to terminate the transmission of the audio data and releasing the second channel.

According to another aspect of the present invention, an audio processing device for remote desktop protocol is provided, comprises: a first connection unit adapted to establish a first channel by initiating a connection with a client upon receiving an audio transmission request from an operating system of a server; and a transmission unit adapted to receive audio data and transmit the audio data to the client via the first channel.

According to a preferred embodiment, the first connection unit comprises: a first command generation sub-unit adapted to generate an audio play device object creation command; a first object creation sub-unit adapted to create a first audio play device object at the server based on the audio play device object creation command; and a first connection sub-unit adapted to establish the first channel between the server and the client based on the first audio play device object.

According to a preferred embodiment, the transmission unit comprises: a first command transmission sub-unit adapted to transmit the audio play device object creation command to the client via the first channel; a second object creation unit adapted to create a second audio play device object at the client based on the audio play device object creation command; and a transmission sub-unit adapted to transmit the audio data from the server to the second audio play device object at the client using the first audio play device object at the server.

According to a preferred embodiment, the device further comprises: a first control unit adapted to calculate an audio data transmission parameter and transmit the audio data transmission parameter to the operating system of the server, such that the operating system of the server controls the transmission of the audio data based on the audio data transmission parameter.

According to another aspect of the present invention, an audio processing device for remote desktop protocol is provided, comprises: second connection unit adapted to establish a second channel by initiating a connection with a client upon receiving an audio reception request from an operating system of a server; and a reception unit adapted to receive audio data transmitted from the client via the second channel.

According to a preferred embodiment, the second connection unit comprises: a second command generation sub-unit adapted to generate an audio reception device object creation command; a third object creation sub-unit adapted to create a first audio reception device object at the server based on the audio reception device object creation command; and a second connection sub-unit adapted to establish the second channel between the server and the client based on the first audio reception device object.

According to a preferred embodiment, the reception unit comprises: a second command transmission unit adapted to transmit the audio reception device object creation command to the client via the second channel; a fourth object creation sub-unit adapted to create a second audio reception device object at the client based on the audio reception device object creation command; and a reception sub-unit adapted to receive the audio data using the second audio reception device object at the client and transmit the received audio data to the first audio reception device object at the server via the second channel.

According to a preferred embodiment, the device further includes: a second control unit adapted to receive an audio reception termination command which notifies the client to terminate the transmission of the audio data and release the second channel.

It can be seen that, according to the present invention, a first channel is established by initiating a connection with a client upon receiving an audio transmission request from an operating system of a server. The audio data is received and transmitted to the client via the first channel. With the solutions provided by the embodiments of the present invention, the connection is initiated with the client after receiving the audio transmission request from the operating system of the server. In this way, a dedicated channel (i.e., the first channel) is established for transmitting the audio data and the audio data is transmitted to the client via the dedicated channel.

### BRIEF DESCRIPTION OF THE DRAWINGS

FIG. 1 is a flowchart illustrating a method according to an embodiment of the present invention;

FIG. 2 is a schematic diagram of a scenario according to an embodiment of the present invention;

FIG. 3 is a flowchart illustrating a method according to another embodiment of the present invention;

FIG. 4 is a flowchart illustrating a method according to another embodiment of the present invention;

FIG. 5 is a flowchart illustrating a method according to another embodiment of the present invention;

FIG. 6 is a schematic diagram showing the structure of a device according to an embodiment of the present invention;

FIG. 7 is a schematic diagram showing the structure of a unit in a device according to an embodiment of the present invention;

FIG. 8 is a schematic diagram showing the structure of a device according to another embodiment of the present invention;

FIG. 9 is a schematic diagram showing the structure of a device according to another embodiment of the present invention;

FIG. 10 is a schematic diagram showing the structure of a unit in a device according to another embodiment of the present invention; and

FIG. 11 is a schematic diagram showing the structure of a unit in a device according to another embodiment of the present invention.

### DETAILED DESCRIPTION OF THE PREFERRED EMBODIMENTS

The embodiments of the present invention relate to an audio processing method and device for remote desktop protocol. In the following, the present invention will be further detailed with reference to the figures, such that the above objects, features and advantages of the present application can become more apparent.

Referring to FIG. 1, according to an embodiment of the present invention, an audio processing method for remote desktop protocol is provided, which includes the following steps of:

At step S101, a first channel is established by initiating a connection with a client upon receiving an audio transmission request from an operating system of a server.

The audio transmission request can be transmitted by the system either initiatively or at the request of the client. For example, the system may initiatively play background music to a client connected thereto, in which case the system transmits the audio transmission request initiatively. Alternatively, a user may wish to listen to music using a client connected to the remote desktop protocol, in which case the system transmits the audio transmission request at the request of the client.

At step S102, the audio data is received and transmitted to the client via the first channel.

With the solutions provided by the embodiments of the present invention, the connection is initiated with the client after receiving the audio transmission request from the system. In this way, a dedicated channel (i.e., the first channel) is established for transmitting the audio data and the audio data is transmitted to the client via the dedicated channel.

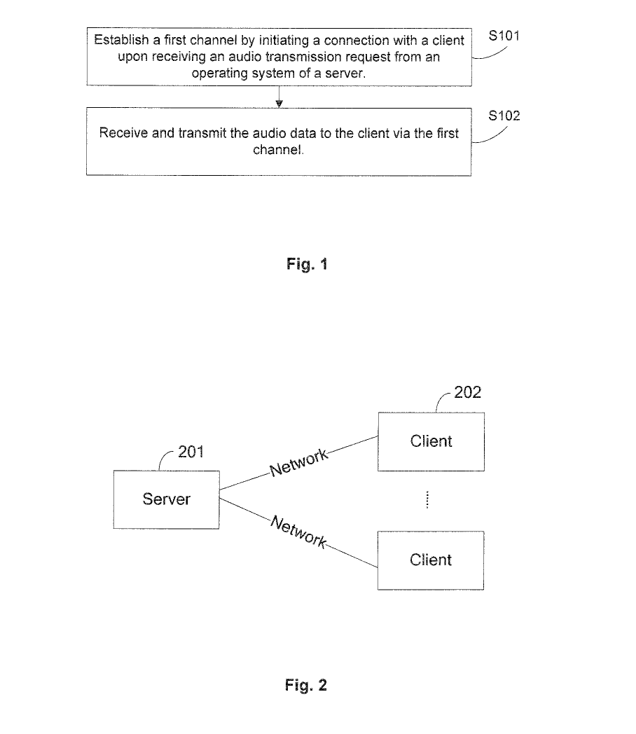

FIG. 2 shows a particular scenario in which the RDP according to an embodiment of the present invention is applied. As shown, the RDP includes a server 201 and a number of clients 202. The server and the clients are connected with each other via a network. The server provides services to the respective clients via the RDP. According to an embodiment of the present invention, the server can provide a remote audio play service to the clients via the RDP.

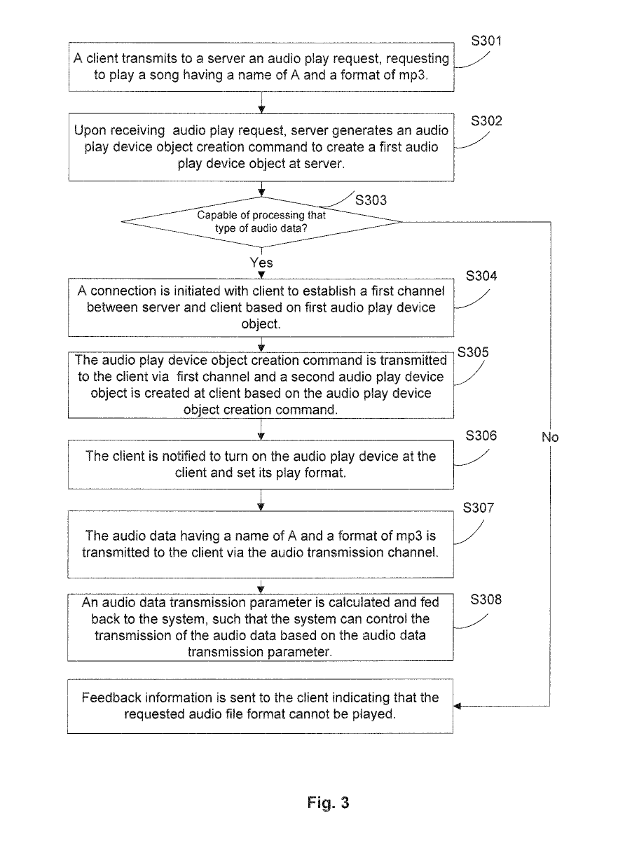

Referring to FIG. 3, based on the scenario shown in FIG. 2, the method according to an embodiment of the present invention can include the following steps.

At step S301, a client transmits to a server an audio play request, requesting to play a song having a name of A and a format of mp3.

The client can transmit the command via an existing static channel between the client and the server.

At step S302, upon receiving the audio play request, the server generates an audio play device object creation command to create a first audio play device object at the server.

At step S303, the server compares the mp3 format with the formats the first audio play device object can play and, based on the comparison, determines whether the audio play device can play music of the mp3 format. If so, the method proceeds with step S304; otherwise, feedback information is sent to the client indicating that the requested audio file format cannot be played.

The operating system of the server checks the channel and frequency capabilities (e.g., dual-channel, 44.1 kHz) the first audio play device object can support. The operating system converts an audio stream provided by player software into an audio stream having one of the channel and frequency capabilities supported by the first audio play device object. For example, the operating system compares the channel and frequency capabilities required by an mp3 player with the channel and frequency capabilities which can be provided by the first audio play device object and, based on the comparison as well as its own conversion capability, determines whether the first audio play device object is capable of playing the music of the mp3 format. If so, the method proceeds with step S304; otherwise, the feedback information is sent to the client indicating that the requested audio file format cannot be played.

The method according to the embodiment of the present invention is not limited to any specific audio file format the audio play device can play.

At step S304, a connection is initiated with the client to establish a first channel between the server and the client based on the first audio play device object.

This audio transmission channel is a dedicated channel established for transmitting audio data according to the method of the present invention. In practice, the server can initiate the connection with the client in accordance with a network communication protocol such as TCP protocol or UDP protocol, so as to establish the audio transmission channel.

TCP is a connection oriented protocol and UDP is a non-connection oriented protocol. For a connection compliant with the UDP protocol, data is transmitted after a three way handshake process and, for each transmitted data packet, acknowledge information returned back from the receiving side is required.

Both TCP and UDP protocols need to form an abstract channel between the server and the client based on the IP addresses and ports at both sides for data transmission. That is, the header of each data packet has so-called label information. In this way, the server side and the client side can identify the destination and source addresses of a data packet.

At step S305, the audio play device object creation command is transmitted to the client via the first channel and a second audio play device object is created at the client based on the audio play device object creation command.

According to the method of the present invention, the first and the second audio play device objects can be created at the client and the server, respectively, based on the audio play device object creation command. Since the first and the second audio play device objects are created based on the same audio play device object creation command, there is a mapping relationship between the first and the second audio play device objects. The operating system of the server can operate on the first audio play device object, which is equivalent to operating on the second audio play device object at the client.

At step S306, the client is notified to turn on the audio play device at the client and set its play format.

The audio play device at the client can be a real physical device for the second audio play device object at the client, such as an audio card or a speaker.

According to the embodiment of the present invention, the established audio transmission channel is used for transmission of commands as well as audio data between the server and the client. In order to determine whether a data packet transmitted on the audio transmission channel is an audio channel command or an audio data, some information can be used to identify the data packet. For example, different types can be defined for the header of the data packet to distinguish between different types of data packets.

According to an embodiment of the present invention, as an example, a header flag type A of a data packet is used to notify the client to turn on the audio play device, so as to turn on the audio device and indicate a device type of audio out. The client can determine from the header flag that the notification is for turning on the audio play device. The client then requests to play an audio file of mp3 format. Thus, the audio play format of the audio play device is set as mp3.

At step S307, the audio data having a name of A and a format of mp3 is transmitted to the client via the audio transmission channel.

In particular, the server transmits the audio data to the first audio play device object which in turn transmits the audio data to the second audio play device object via the audio transmission channel.

At step S308, an audio data transmission parameter is calculated and fed back to the system, such that the system can control the transmission of the audio data based on the audio data transmission parameter.

According to an embodiment of the present invention, the audio data transmission parameter includes the audio data already transmitted and the audio data to be transmitted over the audio transmission channel. The system can monitor the transmission of the audio data based on the transmission parameter. After the audio data transmission is completed, the system can turn off the audio play device at the server. Further, after the audio data transmission is completed, the system can also release the audio transmission channel. For example, when the audio transmission channel established between the server and the client is based on TCP protocol, the system also needs to turn off a socket connection.

According to an embodiment of the present invention, both audio data and audio-related commands are transmitted on the audio transmission channel. In particular, a data packet can be transmitted to the client to turn off the audio play device. In this case, the data packet can be an audio-related command and can be identified using a header flag which may be set as type B to turn off the audio device and indicate a device type of audio out. The client can identify the notification for turning off the audio play device based on the header flag.

In practice, many audio data to be transmitted to the client are mixed audio data, such as the audio data inputted by audiodg.exe in server2008. According to an embodiment of the present invention, when a request to transmit these audio data is received, the audio data can be transmitted immediately to the client via the dedicated channel for audio data (audio transmission channel) as created in the above embodiments. No data buffering is required at the server prior to the transmission. According to the method of the present invention, when the audio data is transmitted over the audio transmission channel, a statistical variable is updated based on information on audio data length, for example. According to the method of the present invention, the header information of a data packet for the audio data can be used to notify the client that it is receiving an audio data packet. For example, a data packet having a header flag of type C can be defined as an audio data packet and indicate a device type of audio out. In this way, the client can determine that it is receiving the audio play data based on only the header information of the data packet.

After receiving the audio data via the network, the client can buffer the audio data for a time period of 100-200 ms and then play it using the local audio device at the client.

For unmixed audio data (such as the audio data transmitted to dll in server2003), according to the method of the present invention, it is possible to mix multiple channels of audio data (e.g., multiple channels of audio data may be present when a user turns on more than one player for playing simultaneously) and transmit the mixed audio data to the client via the audio transmission channel. In this case, no data buffering is required at the server and the statistical variable can be updated based on the information on audio data length. The header information of a data packet for the audio data can be used to notify the client that it is receiving an audio data packet. In particular, the header flag can be set as type C and indicate the device type of audio out. In this way, the client can determine that it is receiving the audio play data based on only the header information of the data packet.

Again, after receiving the audio data via the network, the client can buffer the audio data for a time period of 100-200 ms and then play it using the local audio device at the client.

In other embodiments of the present invention, the audio-related commands can be transmitted between the server and the client via an existing static channel in the RDP. For example, the client can transmit an audio play request to the server via an existing static channel between the client and the server. Upon receiving the audio play request, the server generates an audio play device object creation command and transmits it to the client via the existing static channel. In this way, the server and the client can create the first and the second audio play device objects, respectively, based on the audio play device object creation command. Then, the first channel can be established between the first and the second audio play device objects.

In the above process, after the establishment of the first channel, the audio data can be transmitted from the server to the client with reference to steps S306 to S308.

According to the embodiment of the present invention, the commands between the server and the client are transmitted over the existing static channel in the RDP. The first channel can be established for transmitting audio data only. In this way, the command packets and the data packets can be transmitted over different channels, in which case they do not need any type flag of the header.

In the existing audio play schemes, such as the original audio out in Windows system, the server buffers audio data, subjects it to a complicated encapsulation, writes it into a share memory and notifies the RDP service process rdpclip.exe based on events (about every 0.4 second). Then the RDP service process encrypts the data over a RDP sound static channel and transmits it to the client. The client decrypts the received audio data, buffers it for 200 ms and then plays it, resulting in a high delay. According to the method of the present invention, a dedicated channel, the first channel (in particular, the audio play channel), is established for playing audio data. With the dedicated audio play channel, the buffering process at the server can be avoided during the transmission of the audio data, such that the delay can be greatly reduced.

In addition, the method according to the embodiment of the present invention is not limited to the respective systems at the server and the client. Thus, the inventive method is easy to implement and has an extensive applicability.

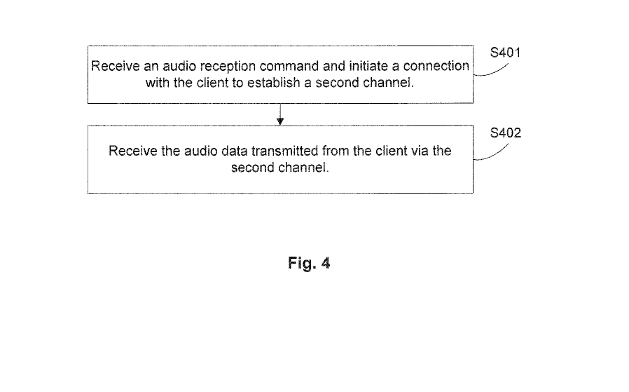

Referring to FIG. 4, according to another embodiment of the present invention, an audio processing method for remote desktop protocol is provided, which includes the following steps.

At step S401, an audio reception command is received and a connection is initiated with the client to establish a second channel.

The audio reception request can be transmitted by the system either initiatively or at the request of the client. For example, the system may request a user of the client to input a segment of voice, in which case the system transmits the audio reception request initiatively. Alternatively, a user may wish to record a song he/she sings using a client connected to the remote desktop protocol, in which case the system transmits the audio transmission request at the request of the client.

At step S402, the audio data transmitted from the client is received via the second channel.

With the solutions provided by the embodiments of the present invention, the connection is initiated with the client after receiving the audio reception request from the system. In this way, a dedicated channel (the second channel) is established for receiving the audio data and the audio data is received from the client via the dedicated channel.

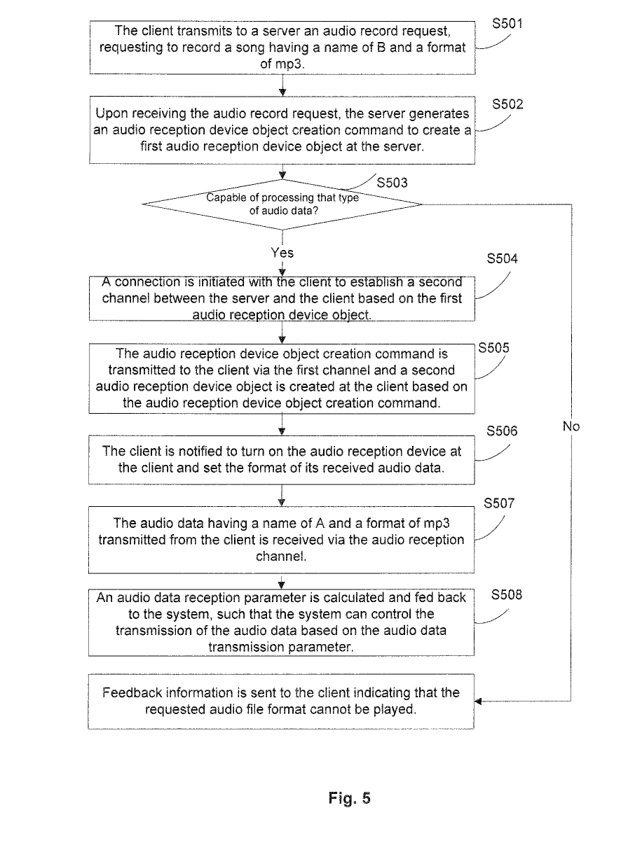

Again, the application scenario shown in FIG. 2 is used as an example in which the user of the client wants to record a song of mp3 format using the server 201. Referring to FIG. 5, the method according to an embodiment of the present invention can include the following steps.

At step S501, the client transmits to a server an audio record request, requesting to record a song having a name of B and a format of mp3.

At step S502, upon receiving the audio record request, the server generates an audio reception device object creation command to create a first audio reception device object at the server.

At step S503, the server compares the mp3 format with the formats the first audio reception device object can play and, based on the comparison, determines whether the audio reception device can receive a music data of the mp3 format. If so, the method proceeds with step S504; otherwise, feedback information is sent to the client indicating that the requested audio file format cannot be received. The method according to the embodiment of the present invention is not limited to any specific audio file format the audio play device can receive.

The operating system of the server checks the channel and frequency capabilities (e.g., dual-channel, 44.1 kHz) the first audio reception device object can support. The operating system converts an audio stream provided by the first audio reception device into an audio stream having the channel and frequency capabilities supported by recording software. For example, the operating system compares the channel and frequency capabilities required by mp3 recording software with the channel and frequency capabilities which can be provided by the first audio reception device and, based on the comparison as well as its own conversion capability, determines whether the first audio reception device object is capable of recording the music of the mp3 format. If so, the method proceeds with step S504; otherwise, feedback information is sent to the client indicating that the requested audio file format cannot be recorded.

At step S504, a connection is initiated with the client to establish a second channel between the server and the client based on the first audio reception device object.

This audio reception channel is a dedicated channel established for receiving audio data according to the method of the present invention. In practice, the server can initiate the connection with the client in accordance with a network communication protocol such as TCP protocol or UDP protocol, so as to establish the audio reception channel. The process of establishing the audio reception channel is similar with the process for establishing the audio transmission channel and the detailed description thereof will be omitted here.

At step S505, the audio reception device object creation command is transmitted to the client via the first channel and a second audio reception device object is created at the client based on the audio reception device object creation command.

The first and the second audio reception device objects are created based on the audio reception device object creation command. Thus, there is a mapping relationship between the first and the second audio reception device objects, which is similar with the relationship between the first and the second audio play device objects and the detailed description thereof will be omitted here.

At step S506, the client is notified to turn on the audio reception device at the client and set the format of its received audio data.

According to the embodiment of the present invention, the audio reception device at the client can be a real physical object for the second audio reception device object at the client, such as an audio card or a speaker.

According to the embodiment of the present invention, the audio data and the audio-related commands are both transmitted over the audio reception channel. A header flag type A of a data packet, which indicates that an audio-related command is transmitted in the data packet, is used to notify the client to turn on the audio reception device, so as to turn on the audio device and indicate a device type of audio in. The client can determine from the header flag that the notification is for turning on the audio reception device. The client then requests to record an audio file of mp3 format. Thus, the audio reception format of the audio reception device is set as mp3.

At step S507, the audio data having a name of A and a format of mp3 transmitted from the client is received via the audio reception channel.

At step S508, an audio data reception parameter is calculated and fed back to the system, such that the system can control the transmission of the audio data based on the audio data transmission parameter.

According to an embodiment of the present invention, the audio data reception parameter includes volume, number of channels, audio frequency, audio data length, and the like. The system can monitor the transmission of the audio data based on the reception parameter.

Further, after the audio data reception is completed, the system can also release the audio reception channel. For example, when the audio reception channel established between the server and the client is based on TCP protocol, the system also needs to turn off the socket connection. In particular, a data packet can be transmitted to the client to turn off the audio play device. In this case, the data packet can have a header flag of type B to turn off the audio device and indicate a device type of audio in. The client can identify the notification for turning off the audio play device based on the header flag.

When the audio data and the audio-related commands are transmitted over separate channels, different identifiers can be set to distinguish between the audio data and the audio-related commands depending on actual implementation. The present invention is not limited to any specific distinguishing identifier.

In practice, when the client records an audio using a local recording device, the recorded audio data can be transmitted to the server via the audio reception channel without any buffering. The server can identify that the received data is the audio data to be recorded, based on the header information of the audio data packet. In particular, the audio data packet can use a header flag of type C and indicate a device type of audio in.

Upon receiving the recording data, the server removes the header flag and notifies the system of data arrival. Then, the system can perform remote recording using a local audio recording device.

According to the method of the present invention, a statistical variable can be updated based on the information on audio data length. For example, the statistical variable can be calculated and returned to the system. For information on volume configuration, the value of the corresponding status variable can be modified and notified to the client via the above described dedicated channel to update the recording configuration. A header flag of type D can be used to notify to the client that it is receiving a configuration packet and indicates a device type of audio in.

As discussed above, the audio-related commands can be transmitted between the server and the client via an existing static channel in the RDP. For example, the client can transmit an audio record request to the server via an existing static channel between the client and the server. Upon receiving the audio record request, the server generates an audio reception device object creation command and transmits it to the client via the existing static channel. In this way, the server and the client can create the first and the second audio reception device objects, respectively, based on the audio reception device object creation command. Then, the second channel can be established between the first and the second audio reception device objects.

In the above process, after the establishment of the second channel, the audio data transmitted from the client can be received with reference to steps S506 to S508.

According to the embodiment of the present invention, the commands between the server and the client are transmitted over the existing static channel in the RDP. The second channel can be established for receiving audio data only. In this way, the command packets and the data packets can be transmitted over different channels, in which case they do not need any type flag of the header.

According the method of the present invention, a dedicated audio reception channel is established such that the client can transmits the audio data to be recorded to the server via the dedicated channel without buffering the audio data.

In addition, the method according to the embodiment of the present invention is not limited to the respective systems at the server and the client. Thus, the inventive method is easy to implement and has an extensive applicability.

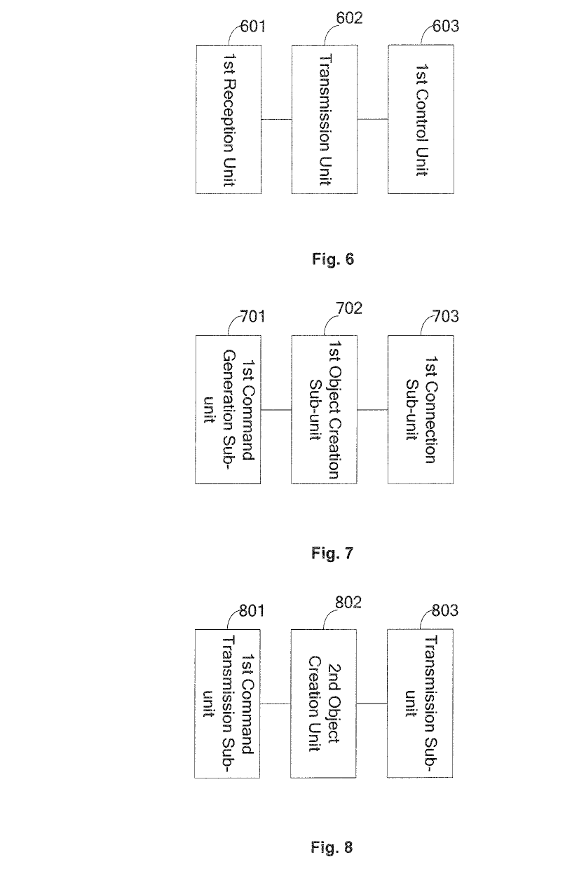

Referring to FIG. 6, according to another embodiment of the present invention, an audio processing device for remote desktop protocol is provided at the server, which includes:

a first connection unit 601 adapted to establish a first channel by initiating a connection with a client upon receiving an audio transmission request from an operating system of a server; and

a transmission unit 602 adapted to receive audio data and transmit the audio data to the client via the first channel.

Referring to FIG. 7, the first connection unit 601 includes:

a first command generation sub-unit 701 adapted to generate an audio play device object creation command;

a first object creation sub-unit 702 adapted to create a first audio play device object at the server based on the audio play device object creation command; and

a first connection sub-unit 703 adapted to establish the first channel between the server and the client based on the first audio play device object.

Referring to FIG. 8, the transmission unit 602 includes:

a first command transmission sub-unit 801 adapted to transmit the audio play device object creation command to the client via the first channel;

a second object creation unit 802 adapted to create a second audio play device object at the client based on the audio play device object creation command; and

a transmission sub-unit 803 adapted to transmit the audio data from the server to the second audio play device object at the client using the first audio play device object at the server.

According to another embodiment, the device as shown in FIG. 6 further includes:

a first control unit 603 adapted to calculate an audio data transmission parameter and transmit the audio data transmission parameter to the operating system of the server, such that the operating system of the server controls the transmission of the audio data based on the audio data transmission parameter.

With the device provided by the embodiment of the present invention, a dedicated channel, the first channel (in particular, the audio play channel), is established for playing audio data. With the dedicated audio play channel, the buffering process at the server can be avoided during the transmission of the audio data, such that the delay can be greatly reduced.

In addition, the device according to the embodiment of the present invention is not limited to the respective systems at the server and the client. Thus, the inventive device is easy to implement and has an extensive applicability.

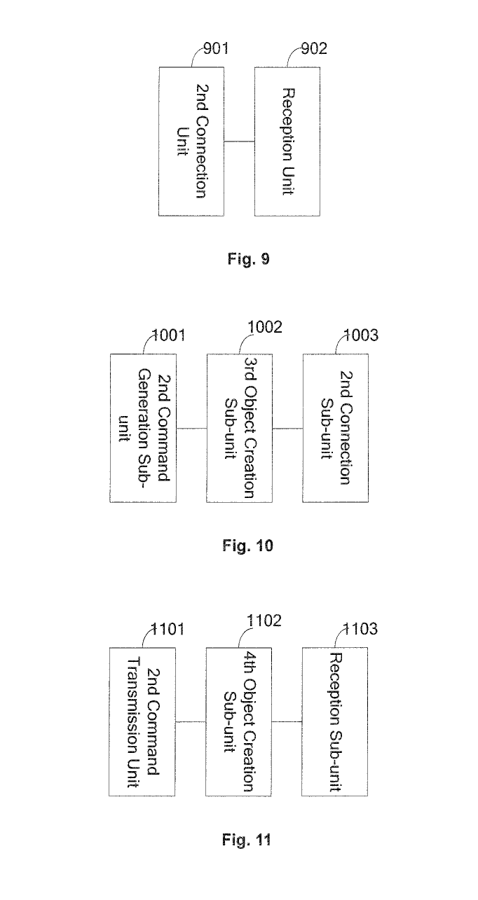

Referring to FIG. 9, according to another embodiment of the present invention, an audio processing device for remote desktop protocol is provided at the server, which includes:

a second connection unit 901 adapted to establish a second channel by initiating a connection with a client upon receiving an audio reception request from an operating system of a server; and

a reception unit 902 adapted to receive audio data transmitted from the client via the second channel.

Referring to FIG. 10, the second connection unit 910 includes:

a second command generation sub-unit 1001 adapted to generate an audio reception device object creation command;

a third object creation sub-unit 1002 adapted to create a first audio reception device object at the server based on the audio reception device object creation command; and

a second connection sub-unit 1003 adapted to establish the second channel between the server and the client based on the first audio reception device object.

Referring to FIG. 11, the reception unit 902 comprises:

a second command transmission unit 1101 adapted to transmit the audio reception device object creation command to the client via the second channel;

a fourth object creation sub-unit 1102 adapted to create a second audio reception device object at the client based on the audio reception device object creation command; and

a reception sub-unit 1103 adapted to receive the audio data using the second audio reception device object at the client and transmit the received audio data to the first audio reception device object at the server via the second channel.

According to another embodiment of the present invention, the device as shown in FIG. 9 includes:

a second control unit 903 adapted to receive an audio reception termination command which notifies the client to terminate the transmission of the audio data and release the second channel.

According the method of the present invention, a dedicated audio reception channel is established such that the client can transmits the audio data to be recorded to the server via the dedicated channel without buffering the audio data.

In addition, the device according to the embodiment of the present invention is not limited to the respective systems at the server and the client. Thus, the inventive device is easy to implement and has an extensive applicability.

The present invention can be described in a generic context of computer executable instructions, such as program modules. In general, a program module includes routines, programs, objects, components and data structures for performing a particular task or implementing a particular abstract data type. Also, the present invention can be implemented in a distributed computing environment where tasks are performed by remote processing devices connected via a communication network. In the distributed computing environment, program modules can be located at local and remote computer storage mediums including memory devices.

The preferred embodiments of the present invention have been described above. It should be noted that a number of variations and modifications can be made by those skilled in the art without departing from the principle of the present invention. These variations and modifications are to be encompassed by the scope of the present invention.

What is claimed is:

1. An audio processing method for remote desktop protocol, comprising steps of:
establishing a first channel by initiating a connection with a client upon receiving an audio transmission request from an operating system of a server; and
receiving audio data and transmitting the audio data to the client via the first channel.

2. The method of claim 1, wherein the step of establishing the first channel comprises steps of:
generating an audio play device object creation command;
creating a first audio play device object at the server based on the audio play device object creation command; and
establishing the first channel between the server and the client based on the first audio play device object.

3. The method of claim 2, wherein the step of transmitting the audio data to the client via the first channel comprises steps of:
transmitting the audio play device object creation command to the client via the first channel;
creating a second audio play device object at the client based on the audio play device object creation command; and
transmitting the audio data from the server to the second audio play device object at the client using the first audio play device object at the server.

4. The method of claim 1, further comprising steps of:
calculating an audio data transmission parameter and transmitting the audio data transmission parameter to the operating system of the server, such that the operating system of the server controls the transmission of the audio data based on the audio data transmission parameter.

5. An audio processing method for remote desktop protocol, comprising steps of:
establishing a second channel by initiating a connection with a client upon receiving an audio reception request from an operating system of a server; and
receiving audio data transmitted from the client via the second channel.

6. The method of claim 5, wherein the step of establishing the second channel comprises steps of:
generating an audio reception device object creation command;
creating a first audio reception device object at the server based on the audio reception device object creation command; and
establishing the second channel between the server and the client based on the first audio reception device object.

7. The method of claim 6, wherein the step of receiving audio data transmitted from the client via the second channel comprises steps of:
transmitting the audio reception device object creation command to the client via the second channel;
creating a second audio reception device object at the client based on the audio reception device object creation command; and
receiving the audio data using the second audio reception device object at the client and transmitting the received audio data to the first audio reception device object at the server via the second channel.

8. The method of claim 5, further comprising steps of:
receiving an audio reception termination command which notifies the client to terminate the transmission of the audio data and release the second channel.

9. An audio processing device for remote desktop protocol, comprising:
a first connection unit adapted to establish a first channel by initiating a connection with a client upon receiving an audio transmission request from an operating system of a server; and
a transmission unit adapted to receive audio data and transmit the audio data to the client via the first channel.

10. The audio processing device of claim 9, wherein the first connection unit comprises:
a first command generation sub-unit adapted to generate an audio play device object creation command;
a first object creation sub-unit adapted to create a first audio play device object at the server based on the audio play device object creation command; and
a first connection sub-unit adapted to establish the first channel between the server and the client based on the first audio play device object.

11. The audio processing device of claim 10, wherein the transmission unit comprises:
a first command transmission sub-unit adapted to transmit the audio play device object creation command to the client via the first channel;
a second object creation unit adapted to create a second audio play device object at the client based on the audio play device object creation command; and
a transmission sub-unit adapted to transmit the audio data from the server to the second audio play device object at the client using the first audio play device object at the server.

12. The audio processing device of claim 9, further comprising:
a first control unit adapted to calculate an audio data transmission parameter and transmit the audio data transmission parameter to the operating system of the server, such that the operating system of the server controls the transmission of the audio data based on the audio data transmission parameter.

13. An audio processing device for remote desktop protocol, comprising:
a second connection unit adapted to establish a second channel by initiating a connection with a client upon receiving an audio reception request from an operating system of a server; and
a reception unit adapted to receive audio data transmitted from the client via the second channel.

14. The audio processing device of claim 13, wherein the second connection unit comprises:
a second command generation sub-unit adapted to generate an audio reception device object creation command;
a third object creation sub-unit adapted to create a first audio reception device object at the server based on the audio reception device object creation command; and
a second connection sub-unit adapted to establish the second channel between the server and the client based on the first audio reception device object.

15. The audio processing device of claim 14, wherein the reception unit comprises:
a second command transmission unit adapted to transmit the audio reception device object creation command to the client via the second channel;
a fourth object creation sub-unit adapted to create a second audio reception device object at the client based on the audio reception device object creation command; and
a reception sub-unit adapted to receive the audio data using the second audio reception device object at the client and transmit the received audio data to the first audio reception device object at the server via the second channel.

16. The audio processing device of claim 13, further comprising:
a second control unit adapted to receive an audio reception termination command which notifies the client to terminate the transmission of the audio data and release the second channel.
